(19) United States
(12) Patent Application Publication
(10) Pub. No.: US 2002/0186146 A1
(43) Pub. Date: Dec. 12, 2002

(54) Crash alarm system

(76) Inventors: Vadim V. Mikhaylenko, Jacksonville, FL (US); Marvin A. Pringle, St. George, GA (US)

Correspondence Address: Jeffrey C. Maynard, 325 Creswell Road, Severna Park, MD, 21146, US

(21) Appl. No.: 09/878,691

(22) Filed: Jun. 11, 2001

(51) Int. Cl. G08G 1/00; B60Q 1/00

(52) U.S. Cl. 340/902; 340/425.5

(57) ABSTRACT

A system and method for instantly communicating to and substantially simultaneous reception by a plurality of receivers, a signal warning of the occurrence and location of a calamitous event, for example, automobile collisions, natural disasters, unnoticeable vehicular accidents, and the like. The system according to the present invention includes a plurality of sensors for automatically detecting a specified event, a controlling unit for processing sensor information, a signal transmitter for instantly reporting the event, a signal receiver for direct reception of signal transmissions, and an alarm for notifying a user of an accident and its location. Communication is conducted directly to all receiver means in the proximate area of such signal transmitter. The system can be deployed independent of vehicular function. Distress signals may be activated manually. The method of using such system enables instant simultaneous direct notification concerning such calamitous event to all receiver devices thereby enabling the possessor of such device to avoid such calamitous event or to render aid to victims of such event, if able.

### BACKGROUND OF THE INVENTION

1. Field of the Invention

The present invention generally relates to emergency locator devices and in particular to a system and method for sensing vehicle calamities and transmitting location signals automatically and directly to receiving devices.

2. Background of the Prior Art

Information concerning the location of vehicles is important for many reasons, including business, safety, and security. Current emergency locator beacons are built into vehicles, such as aircraft, to broadcast a distress signal during emergency conditions. The distress signal communicates the occurrence of an emergency to rescue teams and assists the rescue team in locating the emergency site. Generally, distress signal detectors are positioned at two or more locations to identify the relative direction of such distress signals. The relative directions detected by the respective signal detectors are correlated to identify the specific location of the emergency beacon transmitting the distress signal. Such systems, however, do not enable communication regarding the accident to other vehicles within the proximity to prevent further accidents.

Furthermore, conventional vehicle location systems are based upon the detection by several receiver stations of encoded signals transmitted from a large number of vehicles. A central processing system identifies a transmitting vehicle and determines the location of the specific vehicle by comparing the frequency of the vehicle-transmitter signal against a benchmark transmitter signal mounted at a known, fixed location. Such location systems often require the construction of at least three or four receiving stations, rendering establishment of the system to be very expensive.

Sophisticated vehicle location systems have been disclosed wherein a satellite-based system determines vehicle position through wireless telephone signal transmissions. Location data is generated only after communication via a wireless telephone network. Thus, in such systems, two-way communication is required.

Therefore, there exists a need for a low cost emergency locator device that has the capability of being applied to many vehicles without requiring construction of several receiving stations or costly satellite-based systems.

### SUMMARY OF THE INVENTION

The present invention overcomes the above-referenced shortcomings by using sensors for specific accident conditions, transmitters for signal relay within a specific geographical region, and vehicle-mounted signal receivers for receiving transmitted signals. More specifically, the present invention enables a system and method for sensing and communicating the occurrence of a calamity, having a signal transmitter operatively connected to an accident sensor to communicate to a plurality of vehicle-mounted signal receivers within a specified geographic region.

Accordingly, an object of the present invention is to provide a method for locating a vehicle in distress and for alerting proximate vehicles of an accident site so as to forewarn against further subsequent accidents.

Another object of the present invention is to ensure safe and secure driving conditions.

Yet another object of the present invention is to prevent further calamities from ensuing from an accident by enabling early detection and warning.

A further object of the present invention is to provide a method for communicating the occurrence and location of an accident to vehicles within a specified geographic proximity of such accident.

Another object of the present invention is to enable the disclosed methodology for a plurality of vehicles to reduce costs often associated with vehicular locator and emergency distress systems. A related object of the invention is to enable a system that can be integrated with existing distress and warning systems.

Another object is to enable an autonomous system and method operable independent of a vehicle.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a high level flow diagram illustrating the operation of a crash alarm system consistent with the present invention;

FIGS. 2, 3, and 4 are pictorial drawings depicting alternate embodiments of a crash alarm system in accordance with the present invention, showing by way of illustrative examples, transmission of a signal alerting proximate vehicles of a calamity occurrence and location;

FIG. 5 is a diagrammatic layout of a vehicle illustrating one embodiment of the present invention; and

FIG. 6 is a block diagram of a control unit for processing sensor and receiver information consistent with the present invention.

### DETAILED DESCRIPTION

The invention summarized above and defined by the enumerated claims may be better understood by referring to the following detailed description, which should be read in conjunction with the accompanying drawings in which like reference numbers are used for like parts. This detailed description of particular embodiments, set out below to enable one to practice the invention, is not intended to limit the enumerated claims, but to serve as a particular example thereof. Those skilled in the art should appreciate that they can readily use the concepts and specific embodiments disclosed as a basis for modifying or designing other methods for carrying out the same purposes of the present invention. Those skilled in the art should also realize that such equivalent methods do not depart from the spirit and scope of the invention in its broadest form.

In the following detailed description, the methodology of the embodiments will be described and it is to be understood that it is within the capabilities of a non-inventive worker in the art to introduce the methodology on any standard transmitter, receiver or transceiver by means of appropriate sensing and programming.

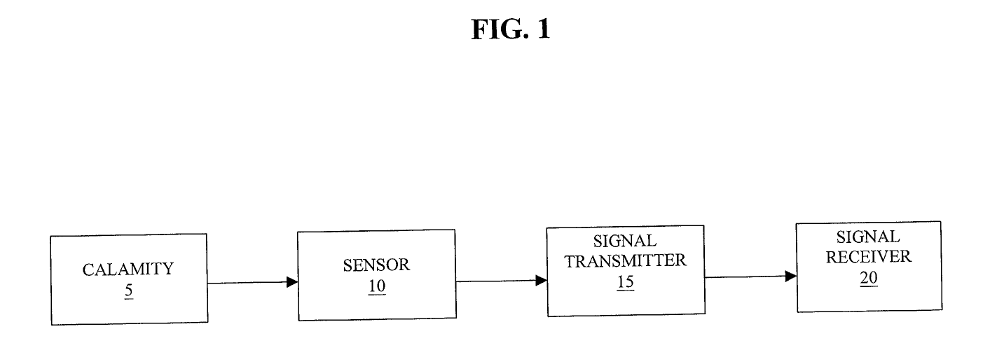

FIG. 1 is a high level flow diagram of the operational steps of a crash alarm system according to the present invention. The first step is the occurrence of a calamity indicated in block 5. In the next step, indicated at block 10, a sensor, upon detecting such calamitous event, automatically causes the activation of a signal transmitter. Block 15 illustrates the next step in which the signal transmitter commences a signal broadcast. The final step, indicated at block 20, assumes by way of example that a signal receiver senses the signal broadcast directly from the signal transmitter and immediately alerts a user of the calamity and its proximate location. To determine the precise location of the signal transmission, at least two signal receivers are preferably used for triangulation.

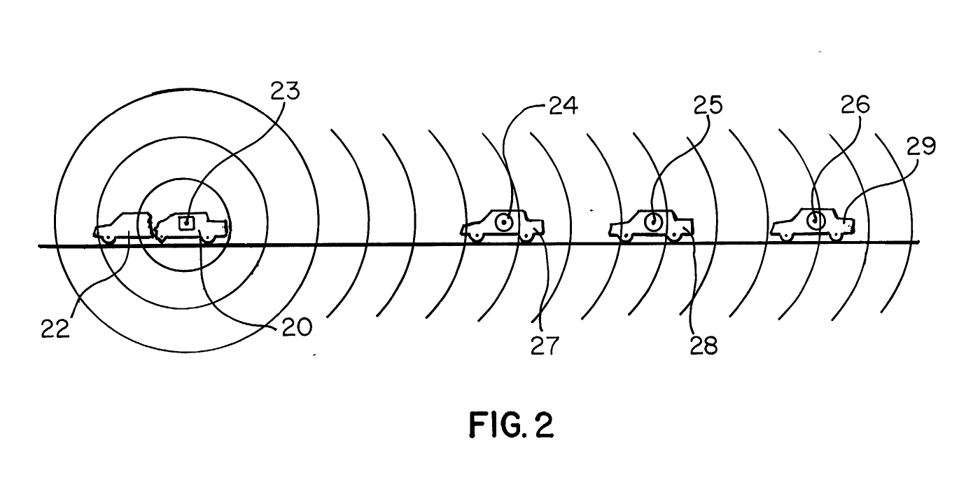

Referring to FIG. 2, operation of a crash alarm system according to present concepts, in relation to an automobile accident is pictorially depicted. In such illustrated embodiment of the present invention, when sensors detect an automobile accident, a signal transmitter is automatically activated to broadcast a signal at a repetitive rate. When vehicle 20 strikes vehicle 22, a signal transmitter 23 in vehicle 20 immediately commences broadcasting a warning signal. The broadcast signal is directly received by vehicle-mounted receptors 24, 25, 26 in vehicles 27, 28, and 29 respectively, to simultaneously warn operators of such vehicles of an accident within the vicinity, so that the operators can avoid the accident or render assistance, if able.

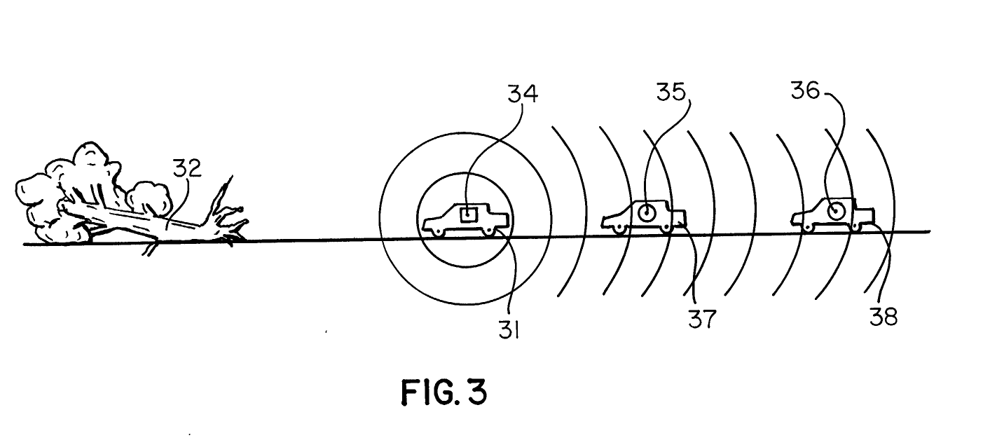

FIG. 3 is a pictorial illustration of the operation of a crash alarm system in an alternate embodiment of the present invention in relation to an accident event. By way of example, the operator of vehicle 31 detects a fallen tree 32 in the middle of the road, and manually activates signal transmitter 34 to broadcast a signal at a repetitive rate. The broadcast signal is received simultaneously by vehicle-mounted receptors 35, 36 in vehicles 37, 38, respectively, to warn the operators of such vehicles of the hazardous condition within the vicinity so as to avoid a potential accident.

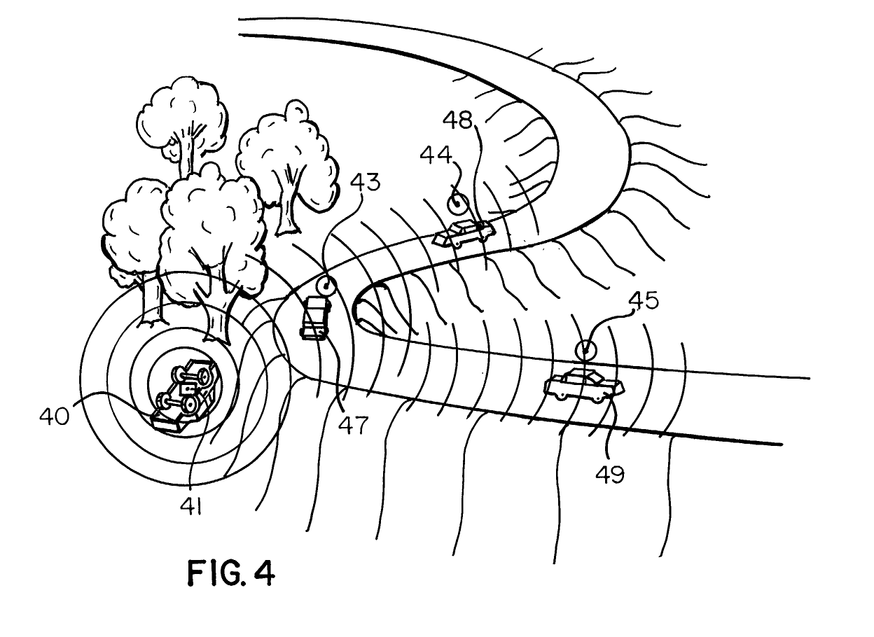

FIG. 4 is a further illustration of the operation of a crash alarm system in an additional embodiment of the present invention in relation to an unseen accident event. Sensors in vehicle 40 detect a vehicular accident and automatically activate a signal transmitter 41 to broadcast a signal at a repetitive rate. The broadcast signal is received simultaneously by vehicle-mounted receptors 43, 44, 45 of passing vehicles 47, 48, 49, respectively, indicating that there is an undetectable vehicular accident within the vicinity. Such operation provides at least two valuable features. First, users within such passing vehicles 47, 48, 49 would ideally notify authorities of a possible accident within the proximity. Second, triangulating the signal transmission would facilitate locating and rescuing the accident vehicle.

In all of the above examples, the transmitted signal is received directly by such receptors, without retransmission by any intermediate source. Such direct transmission and reception enables substantially instantaneous warning of a calamitous event by all proximate receptors substantially simultaneously. Such direct transmission also enables limited reception to only the proximate vicinity of such transmitter.

In an alternate embodiment of the present invention, a signal transmitter may be encompassed in a hand-held apparatus for manual or automatic activation. Signal receivers can receive the broadcast signal generated by a manually carried or vehicular mounted signal transmitter. A further embodiment of the present invention provides signal receivers that also are incorporated in hand-held devices.

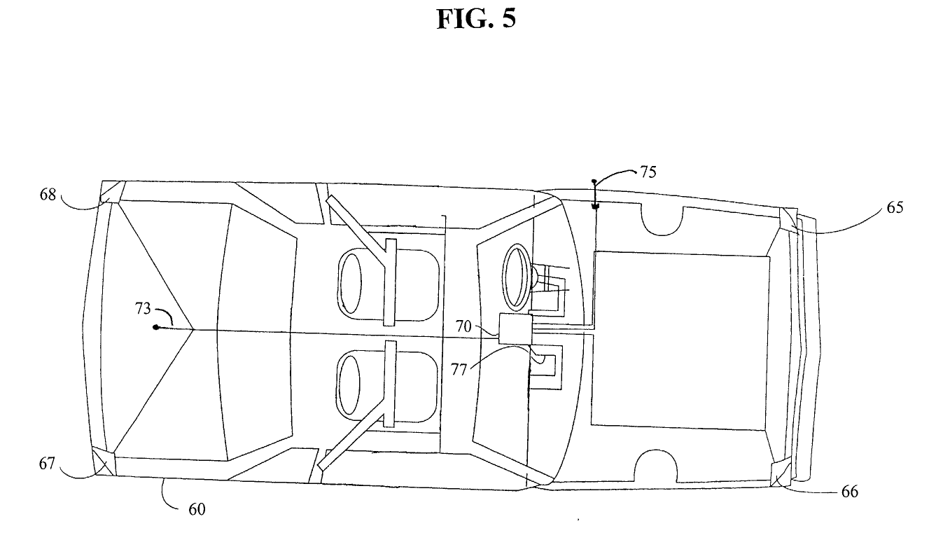

With reference to FIG. 5, a diagrammatic layout of a specific embodiment of the present invention is illustrated. An automobile 60 ideally includes sensors 65, 66, 67, 68. Sensors 65, 66, 67, 68 may be programmed to observe a plurality of factors, including temperature, speed, physical impact, and the like. Sensors 65, 66, 67, 68 are operatively connected to a control unit 70, which may be preferably coupled to a signal receiver 73, a signal transmitter 75, and an alarm 77.

Control unit 70 processes information derived from sensors 65, 66, 67, and 68 to monitor the condition of automobile 60. Upon a given condition of automobile 60, control unit 70 activates signal transmitter 75 to initiate repetitive signal transmission to a plurality of signal receivers 73 within the geographic proximity. Additionally, control unit 70 processes signals received by signal receiver 73 to activate alarm 77 and notify a user of automobile 60 of a nearby accident or calamitous event.

In an alternate embodiment of the present invention, sensors 65, 66, 67, 68 are radar sensors of a low power having an antenna that produces a broad beam-shaped coverage. Sensors 65, 66, 67, 68 can automatically detect the presence of impending obstacles, such as fallen trees, as illustrated in FIG. 3.

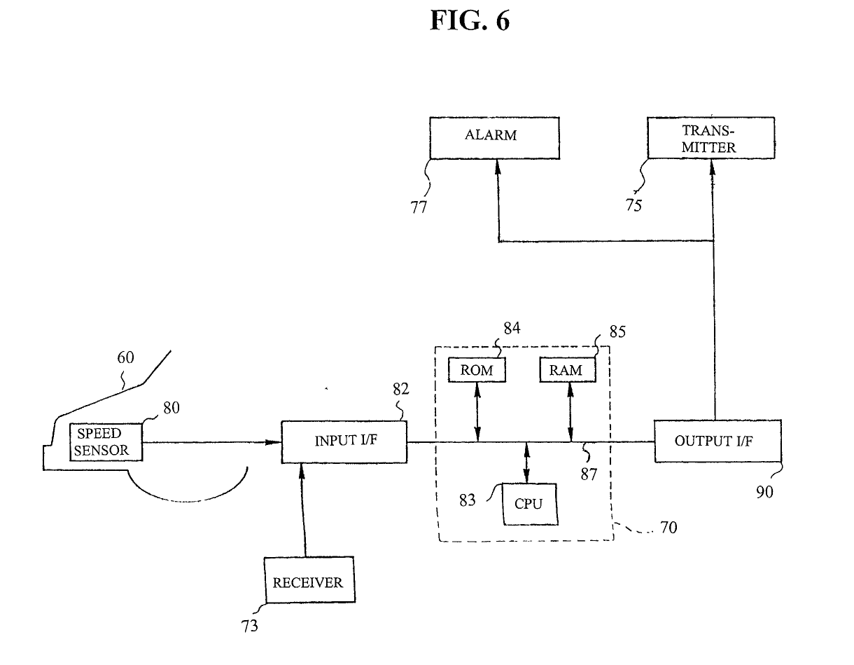

An alternate embodiment of the present invention is shown in FIG. 6. A control unit 70 connected to a speed sensor 80 supplies velocity data to the control unit 70 through input interface 82. The velocity data represents an actual velocity of automobile 60. Control unit 70 includes a central processing unit (CPU) 83, a read-only memory (ROM) 84, and random access memory (RAM) 85. ROM 84 and RAM 85 are operatively connected to each other through a data bus 87. CPU 83 performs proper functions according to programs stored in ROM 84 and RAM 85. The outputs of control unit 70 to either signal transmitter 75 or alarm 77 are transmitted through output interface 90. ROM 84 ideally stores numerical values required for processing the occurrence of an accident.

Although the invention is illustrated and described herein as embodied in an emergency distress signal system for vehicles, it is nevertheless not intended to be limited to the details shown, since various modifications and structural changes may be made therein without departing from the spirit of the invention.

What is claimed is:

1. A method of warning individuals about a calamitous event, comprising:
a. providing detecting means for detecting the occurrence of such calamitous event;
b. providing transmitting means for transmitting a signal;
c. providing receiving means for receiving such transmitted signal;
d. detecting the occurrence of such calamitous event;
e. substantially instantaneously with detecting such calamitous event, transmitting a signal by such transmitting means;
f. receiving such transmitted signal by such receiving means, and
g. such receiving means providing a warning indication of such calamitous event.

2. The method of claim 1, further comprising:
a. providing controller means coupled to the detecting means, the transmitting means, and the receiving means.

3. The method of claim 2, wherein the controller means further comprises
a. a central processing unit;
b. a read-only memory; and
c. a random-access memory.

4. The method of claim 1, wherein the detecting means comprises a sensor coupled to an accelerometer.

5. The method of claim 1, wherein the detecting means comprises a plurality of wave generator means for generating and propagating an electromagnetic wave of predetermined frequency, wavelength, spectrum, duration and power to provide a desired sensing range and for receiving reflected wave off of an obstacle within the range of the wave generator means, the predetermined frequency of the wave being in a radar frequency range.

6. The method of claim 1, wherein the detecting means comprises at least one electrical sensor for sensing momentum changes resulting from a collision.

7. The method of claim 1, wherein the detecting means comprises at least one sensor for observing extreme fluctuations in temperature.

8. The method of claim 1, wherein the transmitting means comprises a radio transmitter for transmitting radio frequency signals at a repetitive rate.

9. The method of claim 1, wherein the receiving means comprises a radio receiver for receiving radio frequency signals.

10. The method of claim 1, wherein the receiving means receives a transmission directly from the transmitting means.

11. The method of claim 1, wherein the warning indication is selected from the group consisting of:
a. a visual signal;
b. an audible signal
c. a mechanical signal, and
d. combinations of visual signals, audible signals and mechanical signals.

12. The method of claim 1, in which
such detection of such calamitous event is performed automatically.

13. The method of claim 1, in which
such detection of such calamitous event is performed manually.

14. The method of claim 1, further comprising:
providing a plurality of receiving means for receiving the transmitted signal, and
in which, such transmitted signal is received simultaneously by all such plurality of receiving means.

15. The method of claim 1, further comprising:
providing means for manually transmitting a signal.

16. The method of claim 1, in which
such detecting means, transmitting means and receiving means are mounted in a vehicle selected from the group consisting of:
a. automobiles;
b. motorcycles;
c. trucks;
d. busses;
e. trains;
f. boats, and
g. personal watercraft.

17. The method of claim 1, in which
such detecting means, transmitting means and receiving means are handcarried.

18. A method of communicating the occurrence and location of a calamitous event to
a plurality of users within a specified geographic location, comprising:
a. automatically sensing by means of a plurality of sensor means mounted on a vehicle such occurrence of the calamitous event;
b. transmitting a signal for indicating the location of such vehicle, and
c. receiving such signal and sending an alarm.

19. A method of communicating the occurrence and location of a calamitous event to
a plurality of users within a specified geographic location, comprising:
a. manually transmitting a signal indicating the location of a user;
b. receiving such signal by a plurality of signal receiver means, and
c. such plurality of signal receivers communicating an alarm and location signal.
